(19) United States
(12) Patent Application Publication
(10) Pub. No.: US 2008/0005432 A1
(43) Pub. Date: Jan. 3, 2008

(54) REMOTE CONTROL SYSTEM AND REMOTE CONTROL DEVICE

(76) Inventor: Tadayoshi KAGAWA, Osaka (JP)

Correspondence Address: OGILVIE LAW FIRM, 1320 EAST LAIRD AVENUE, SALT LAKE CITY, UT, 84105, US

(21) Appl. No.: 11/765,542

(22) Filed: Jun. 20, 2007

(30) Foreign Application Priority Data
Jun. 28, 2006 (JP) JP 2006-178398

(51) Int. Cl. G06F 13/42

(52) U.S. Cl. 710/106

(57) ABSTRACT

A remote control device includes at least one peripheral device interface means, a host selecting means for selecting a host computer on a network, a connection managing means for making a connection to a host computer selected by the host selecting means, a data converting means for mutual protocol conversion between input/output data of a peripheral device connected to the peripheral device interface means and network communication packet data, and a network communicating means for transmitting and receiving network communication packet data to and from a host computer selected by the host selecting means, and the host computer includes a data converting means for converting network communication packet data to be transmitted to and received from the remote control device into input/output data of the peripheral device.

### RELATED APPLICATIONS

This application claims priority to, and incorporates, Japanese patent application no. JP2006-178398 filed Jun. 28, 2006.

### BACKGROUND OF THE INVENTION

The present invention relates to a device which manages peripheral devices such as USB (Universal Serial Bus) compatible devices (hereinafter, referred to as USB device), and a technique for remote controlling a host computer by transmitting or receiving input/output data for the peripheral device to or from the host computer.

1. Background Art

For improving the convenience of the use of USB devices, a device dedicated to using a USB device (for example, USB device server) via a network is known (Non-Patent Document 1).

By using this USB device server, a USB device which could only be conventionally connected to one host computer and used can be used from arbitrary host computers on a network via the network. Each host computer can monitor the status of a USB device connected to this USB device server on a display, or transmit and receive data files as in the case of a locally connected USB device by selecting a USB device from the display screen of each host computer.

For example, a printer or scanner as a USB device connected to a USB device server is selected from a host computer on a network and printer output and scanning data can be loaded.

Thus, a USB device server is a passive device, and a host computer actively performs status monitoring, selection, and data transfer of a USB device via a USB device server.

Herein, a system of a USB device server will be described with reference to FIG. 15. Such a system is composed of host computers (2a, 2b, and 2c), a USB device server 100, and a USB device 41 connected to the USB device server. The host computers (2a, 2b, and 2c) and the USB device server 100 are connected to each other by a LAN network 3, and the USB device server 100 and the USB device 41 are connected to each other by a USB cable 5. A plurality of USB device servers may exist. It is also possible that a plurality of USB devices are connected to the USB device server. When a larger number of USB devices than the number of USB ports of the USB device server are used, they are connected via a USB hub.

Use of the USB device 41 from the host computer 2a will be described.

A user of the host computer 2a operates a USB device server management program (corresponding to the host side connection managing means 28 of FIG. 2) installed in the host computer 2a to request acquisition of information on a USB device server existing on the LAN network 3 and a USB device connected thereto. The USB device server receives this information acquisition request and replies with its own information and information on the USB device connected to itself (for example, name and status, or the like, of the USB device) to the host computer 2a. The USB device server management program in the host computer 2a displays the received information on a GUI (Graphical User Interface) and presents the same to the user.

Information on one or a plurality of USB device servers and USB devices connected to the LAN network 3 are displayed as a list on the GUI of the host computer 2a, so that the user of the host computer 2a selects a USB device (herein, USB device 41) that the user wants to use and executes a connection request. Then, the USB device server management program transmits the connection request to a USB device server 100 to which the selected USB device 41 is connected. The USB device server 100 receives this connection request and establishes a logical connection for USB data transmission and receiving to the host computer 2a. Thereby, USB data transmission and receiving between the host computer 2a and the USB device server 100 via the LAN network 3 become possible.

Next, USB data transmission and receiving processes will be described.

The host computer 2a encapsulates commands and data for the USB device 41 issued from an application into a network protocol such as TCP/IP, or the like, and transmits the encapsulated commands and data to the USB device server 100. The USB device server 100 receives this and decapsulates the same, extracts commands and data and supplies these commands and data to the USB device 41. Thus, the system of the USB device server enables remote control of the USB device from a host computer via a LAN network.

By using this USB device server, a USB device which could only be conventionally connected to one host computer and used can be used from arbitrary host computers on a network via the network. Each host computer can monitor the status of a USB device connected to the USB device server on a display, and transmit and receive data files similarly to a locally connected USB device by selecting a USB device on the display screen of each host computer.

[Non-Patent Document 1] Silex Technology's Website, “USB device server” (URL address: http colon//www dot silex dot jp/japan/products/network/what/index3dot html)

2. Disclosure of the Invention

[Problem to be Solved by the Invention]

As described above, the USB device server is a passive device, and a host computer actively monitors, selects, and transfers data to a USB device via the USB device server, so that, for example, when a scanner is used via a USB device server through a network, a user follows procedures that he/she actively performs an operation for selecting a scanner from a host computer and then moves to the scanner and sets a scanning target, performs a scanning operation, and actively loads scanning data into the host computer. This is not convenient for users.

An object of the present invention is to provide a remote control system in which this USB device server is made to function as an active device to select a host computer and transfer data, and to passively control the host computer.

[Means for Solving the Problem]

In order to achieve the above-described object, a remote control system 1 of the present invention is a system including a remote control device to be connected to one or a plurality of host computers via a network, and one or a plurality of peripheral devices to be connected to the remote control device, wherein the remote control device includes the following 1) through 5) and the host computer includes the following 6) and 7):
1) at least one peripheral device interface means
2) a host selecting means for selecting a host computer on a network based on host computer selection information supplied from the outside
3) a connection managing means for making a connection to a host computer selected by the host selecting means
4) a data converting means for mutual protocol conversion between input/output data of the peripheral device connected to the peripheral device interface means and network communication packet data
5) a network communicating means for transmitting and receiving network communication packet data to and from a host computer selected by the host selecting means
6) a host side network communicating means for transmitting and receiving the network communication packet data
7) a host side data converting means for mutual protocol conversion between network communication packet data to be received from or transmitted to the remote control device via the host side network communicating means and input/output data of a peripheral device.

A remote control device constituting the remote control system of the present invention is essentially a managing device of a peripheral device, and includes an interface means for interfacing with a peripheral device and a network communicating means. Herein, the interface means for interfacing with a peripheral device is a general-purpose interface means connectable to various peripheral devices made by various manufacturers, and preferably, a USB (Universal Serial Bus) interface. The network communicating means is capable of communicating with other computers via a network such as a LAN (Local Area Network). In addition, the remote control device includes a host selecting means for actively selecting a host computer, and a connection managing means for making a connection to a host computer selected by the host selecting means.

The remote control device further includes a data converting means for converting input data of a peripheral device into network communication packet data. Thereby it may transmit input data of a peripheral device to a host computer selected through network communication.

Then, the host computer includes a host side network communicating means for communicating with the remote control device via a network such as a LAN and a host side data converting means for converting packet data received from the remote control device via the network into data for the peripheral device, so that the host computer processes the data as if the data was input from a locally connected peripheral device.

The same applies to an output from the host computer. Data issued by the host computer is converted into network communication packet data by the host side data converting means and transmitted by means of network communication, and the remote control device receives and supplies this to the peripheral device after converting the same by the data converting means, whereby data is forwarded from the host computer to the peripheral device.

Herein, the mutual protocol conversion between input/output data of a peripheral device and network communication packet data means that specific information is added to or conversion is applied to this input/output data of the peripheral device in order to transmit and receive the input/output data of the peripheral device via a LAN network. For example, it means encapsulation of the input/output data of the peripheral device into a network protocol such as TCP/IP, or decapsulation of the network communication packet data of TCP/IP to extract the input/output data of the peripheral device.

That is, by operating the peripheral device connected to the remote control device, a selected host computer performs processing as if a locally connected peripheral device were operated.

The remote control system of the present invention is constructed as described above, so that an arbitrary host computer on a network can be remotely controlled by actively functioning a device which manages a peripheral device.

The above-described remote control system of the present invention further includes a data input means and an image display means to be connected to the peripheral device interface means of the remote control device. Thereby it transmits data input from the data input means as data to be processed by a host computer selected by the host selecting means to this host computer via the data converting means and the network communicating means, and receives image display data of this host computer via the host side data converting means and network communicating means and displays the same on the image display means via the data converting means.

Herein, the data input means connectable to the peripheral device interface means includes a pointing device such as a mouse, a key input device such as a keyboard, and a touch panel to be attached to a display means such as a display. These data input means are connected to the remote control device via general-purpose interfaces such as USBs. The display means connectable to the peripheral device interface means is, for example, a liquid crystal display or the like, and is connected to the remote control device via a general-purpose interface such as a USB similarly to the above-described data input means.

Data input from the data input means such as a mouse or keyboard is transmitted as data to be processed by a host computer selected by the host selecting means to this host computer via the data converting means and the network communicating means, while image display data of this host computer is received via the host side data converting means and the network communicating means and displayed by an image display means such as a liquid crystal display via the data converting means. Thereby, it becomes possible to operate an application exclusively for the host computer (data analysis software or the like) from the remote control device, and the convenience of the peripheral device is significantly improved.

For example, a case where a mouse and a keyboard, or the like, as USB devices are connected to the remote control device is assumed. The remote control device functions as an active device, and a host computer is selected from the remote control device, and the mouse and keyboard, or the like, connected to the remote control device are operated. Pointing data of the mouse and key input data of the keyboard are processed by the selected host computer as input data from the mouse and keyboard locally USB-connected to the host computer. Therefore, the selected host computer is controlled by the remote control device.

As an example of use of such remote controlling of a host computer, an example in which a host computer is remotely controlled from a remote control device to which an analyzer is connected will be described.

In public research facilities, development departments of companies, and laboratories of universities, an expensive analyzer is installed. Recently, in order to save analysis data of the analyzer as electronic files, the types of equipment including USB interfaces as general-purpose interfaces have been on the increase. By using such a USB interface, analysis data collected by the analyzer is loaded into a personal computer and analyzed by using an dedicated application (normally, data analysis software specialized for the analyzer). Herein, it is assumed that this analyzer is connected to the remote control device via the USB interface. Then, the remote control device is made to function as an active device to remotely control a host computer connected to the remote control device via a network. By operating the application (data analysis software or the like) exclusively for the host computer by using a mouse and a keyboard connected to the remote control device, the convenience of the analyzer can be significantly improved.

In addition, in the remote control system of the present invention, the remote control device further includes an input device data switching means, and this input device data switching means allows data input from a peripheral device to be processed as input data for the remote control device when a connection between the remote control device and a host computer is not established, and allows data input from a peripheral device to be processed as input data for the host computer when a connection between the remote control device and the host computer is established.

In the remote control system of the present invention, the remote control device further includes an authenticating means, and the authenticating means performs at least one of the processings (1) through (3) of: (1) comparing whether authentication information supplied from the outside and authentication information registered in the authenticating means match with each other; (2) comparing whether authentication information supplied from the outside and authentication information supplied from a host computer match with each other; and (3) comparing whether host computer selection information matches with host computer information registered in the authenticating means.

The authentication information means information by which a person who accesses the host computer or remote control device can be uniquely identified, and includes a user ID, ID information of an IC card, biometrics information such as a fingerprint image, a password, or the like.

The authentication information supplied from the outside means information supplied from the outside to the remote control device, and includes, for example, a user's fingerprint image to be input from a fingerprint sensor, a password to be input by a user by operating an operation panel of the remote control device, or the like.

The authentication includes user authentication and device authentication, however, it is not limited thereto. User authentication is to enable a user having authorization to remotely control the remote control device or a connection destination host computer, to control the same. The device authentication is to permit remote controlling limited only to a host computer selected in advance by a system administrator or a user.

“Matching” includes the pair relationship of two data when compared in a certain algorithm as well as perfect matching of two data. The pair relationship also includes the case where data to be compared is stored in advance in a table or the like and the two data can be judged as being paired by referring to the table or the like.

In the remote control system of the present invention, the authentication information is used as host computer selection information.

The authentication information can be used as host computer selection information for selecting a host computer in addition to the purpose of authentication. Thereby, a host computer to be connected automatically is determined simply by inputting the authentication information by a user, so that it becomes unnecessary to input authentication information and host computer selection information separately, so that the convenience is increased.

In the remote control device of the present invention, the host computer further includes a host side authenticating means, and the host side authenticating means performs at least one of the processings (1) through (3) of: (1) transmitting authentication information registered in advance to the remote control device in response to a request from the remote control device; (2) comparing whether authentication information received from the remote control device and authentication information registered in advance in the host side authenticating means match with each other; and (3) comparing whether the remote control device which issued a connection request is identified with a remote control device registered in the host side authenticating means when receiving the connection request from the remote control device.

By providing a host side authenticating means in the host computer, a remote control system with higher security can be constructed. More specifically, authentication information of a user who is permitted use is registered in advance in the host computer, and user authentication which permits only this user to remotely control the host computer can be realized. In addition, identification information (IP address or the like) of the remote control device which is permitted to be connected is registered in advance in the host computer, and device authentication which permits only the registered remote control device to access is realized. It is also possible that the authentication information is compared in the host computer.

The remote control system of the present invention described above further includes an application starting means for starting a predetermined application program in response to a signal from the remote control device when the application program is not operating in the host computer.

The remote control system of the present invention aims at improvement in convenience of a peripheral device such as an analyzer by remotely controlling a host computer when an application program for operating the peripheral device exists in the host computer. When the application program for operating the peripheral device is not started on the host computer side, the peripheral device cannot be operated, so that a function for forcibly starting the application program is provided.

In addition, the remote control device of the present invention includes the following means 1) through 5):
1) at least one peripheral device interface means;
2) a host selecting means for selecting a host computer on a network;
3) a connection managing means for making a connection to a host computer selected by the host selecting means based on host computer selection information supplied from the outside;
4) a data converting means for mutual protocol conversion between input/output data of a peripheral device connected to the peripheral device interface means and network communication packet data;
5) a network communicating means for transmitting and receiving network communication packet data to and from a host computer selected by the host selecting means.

The remote control device of the present invention is a component of the above-described remote control system, and includes an interface means for interfacing with a peripheral device and a network communicating means for communicating with a peripheral device, a host selecting means for actively selecting a host computer; and a connection managing means for making connection to a host computer selected by the host selecting means. Furthermore, the remote control device includes a data converting means for mutual protocol conversion between input/output data of a peripheral device connected to the peripheral device interface means and network communication packet data, and transmits or receives network communication packet data to or from a host computer selected by the host selecting means.

With the above-described construction, by operating the peripheral device connected to the remote control device, the selected host computer performs processing as if a locally connected peripheral device was operated.

In the remote control device of the present invention, a data input means and an image display means are connected to the peripheral device interface means, data input from the data input means is transmitted as data to be processed by a host computer selected by the host selecting means to this host computer via the data converting means and the network communicating means, and image display data of this host computer is received via the network communicating means and displayed by the image display means via the data converting means.

Data input from a data input means such as a mouse and a keyboard is transmitted as data to be processed by a host computer selected by the host selecting means to this host computer via the data converting means and the network communicating means, while image display data of this host computer is received via the network communicating means, and displayed by the image display means such as a liquid crystal display via the data converting means. Thereby, it becomes possible to operate an application on the host computer by using a mouse, keyboard, and liquid crystal display connected to the remote control device, and convenience of peripheral devices such as a printer, scanner, and an analyzer connected to the remote control device can be significantly improved.

In addition, the remote control system of the present invention further includes an input device data switching means, and the input device data switching means allows data input from the peripheral device to be processed as input data for the remote control device when a connection between the remote control device and the host computer is not established, and allows data input from the peripheral device to be processed as data for a host computer when a connection between the remote control device and the host computer is established.

In addition to the above-described construction, the remote control device of the present invention performs at least one of the processings (1) through (3) of: (1) comparing whether authentication information supplied from the outside and authentication information registered in the authenticating means match with each other; (2) comparing whether authentication information supplied from the outside and authentication information supplied from the host computer match with each other; and (3) comparing whether host computer selection information matches with host computer information registered in the authenticating means.

In the remote control device of the present invention, the authentication information is used as host computer selection information.

In the remote control device of the present invention, When the connection managing means issues a connection request to the host computer and a connection response could not be received from the host computer in a predetermined time, the connection managing means judges that the host computer is in a non-start status and transmits a signal for canceling this non-start status.

The non-start status means that the host computer is in a status unable to make a normal response to a request from the remote control device, and includes statuses of, for example, sleep, standby, and power shutdown. When the host computer is in the non-start status, by transmitting a signal for canceling the non-start status from the remote control device, a user can continue the connection processing from the remote control device without operating the host computer.

In the remote control system of the present invention, the peripheral device interface means is a USB (Universal Serial Bus).

In the remote control device of the present invention, the peripheral device interface means is a USB (Universal Serial Bus).

The USB (Universal Serial Bus) standards are widely used in computer peripheral devices, and by complying with the standards, various peripheral devices can be used in the remote control system of the present invention.

### EFFECTS OF THE INVENTION

The present invention brings about an effect that, a remote control system in which the remote control device functions as an active device (the remote control device selects a host computer and transfers data) and a host computer functions as a passive device (controlled by the remote control device) can be realized, so that the convenience of peripheral devices such as a printer and scanner connected to the remote control device can be significantly improved.

In addition, the present invention brings about an effect that, all connections and disconnections can be controlled from the remote control device, so that a user can arbitrarily make a connection or a disconnection to an arbitrary host computer existing on a network and remotely control this without leaving a location where the remote control device is installed.

In addition, according to the present invention, by providing the remote control device with a data input means and an image display means, the same human-machine interface as in a connection destination host computer can be provided for the user. Thereby, the present invention brings about an effect that, the user can remotely control this connection destination host computer as if the remote control device were the connection destination host computer itself.

In addition, the present invention brings about an effect that, by providing the remote control device with an input device data switching means, a peripheral device connected to the peripheral device interface means can be used for data input into the remote control device and for data input into a host computer.

In addition, the present invention brings about an effect that, by providing the remote control device with an authenticating means, a remote control system ensuring security can be constructed.

In addition, the present invention brings about an effect that, authentication information can also be used as host computer selection information, so that by simply inputting authentication information, a user can select a connection destination host computer.

In addition, the present invention brings about an effect that, by providing the remote control device with a host computer starting function, even when a host computer is in a non-start status, it is unnecessary for a user to move to a location where the host computer is installed and cancel the non-start status, and therefore, the remote control device automatically issues a cancel command and the processing can be continued.

In addition, the present invention brings about an effect that, by providing the remote control device with a data input means and an image display means, an environment equivalent to that of a connection destination host computer can be provided for a user, and furthermore, a connection can be made to an arbitrary host computer on a network at an arbitrary timing by the host computer starting means, so that the user can remotely control all host computers on the network without leaving a location where the remote control device is installed.

In addition, the present invention brings about an effect that, the remote control device performs processing for directly transferring input data from a peripheral device to a connection destination host computer, and this input data is not stored in a ROM or the like, so that the input data does not remain in the remote control device, and a remote control system with high security can be realized.

### BEST MODE FOR CARRYING OUT THE INVENTION

Hereinafter, embodiments of the present invention will be described in detail with reference to the drawings, in particular, by exemplifying a USB device as a peripheral device. However, the scope of the present invention is not limited to the illustrated examples.

FIG. 1 shows a general system construction diagram of a remote control system of the present invention. In the general system construction diagram of the remote control system of the present invention, as shown in FIG. 1, host computers (2a, 2b, and 2c) and a remote control device 1 are connected by a LAN network 3, and to the remote control device 1, USB devices A (4a) and B (4b) are connected by USB cables 5.

The remote control device 1 includes a CPU 50 for controlling the operation of the remote control device 1, a RAM (random access memory) 52 in which a program and data that the CPU 50 refers to when it is executed are temporarily stored, a ROM (read-only memory) storing a predetermined program that the CPU 50 executes, a LAN I/F 15b for communication via the LAN network 3, a USB port 14b to be connected to a USB device such as a printer or a scanner, and an input means 53 such as a switch or an operation panel. In addition, although not shown, an output means for displaying or sounding for informing a user of various information such as errors may be provided. More specifically, it may be an LED, speaker, or the like, and a user is informed of information by using a LED color change or a sound, or the like.

Next, FIG. 2 shows a functional block diagram of the remote control system of the present invention.

First, the functional block diagram of the remote control device 1 will be described. In the remote control device 1, a USB port 14b as one or a plurality of peripheral device interface means 14 and a USB port driver 14a for controlling the USB ports exist. By this USB port 14b, a connection to the USB device 41 is made.

In addition, a host selecting means 11 for selecting a host computer on a network is provided. The host selecting means 11 includes a host management table 11a and a host selector 11b. The host selector 11b identifies a host computer to be connected based on input data (host computer selection information) supplied from an input means 53 provided integrally with the remote control device 1 or input data (host computer selection information) supplied from the USB device 41 connected to the peripheral device interface means 14. After identifying a host computer to be connected, the host selector 11b supplies the information (IP address or the like of this host computer) to the connection managing unit 12b.

Herein, the input means 53 provided integrally with the remote control device 1 is, for example, a switch or an operation panel of the remote control device 1. The USB device 41 connected to the peripheral device interface means 14 is, for example, an input device such as a keyboard or a fingerprint sensor. The host selecting means 11 identifies a host computer based on input data (host computer selection information) supplied from the USB device 41 and input means 53.

These input data (host computer selection information) may include, for example, fingerprint data itself. In this case, a host computer cannot be identified from the supplied data as it is, so that a host computer is identified by using a host management table 11a registered in advance. More specifically, by registering information that associates the “IP address of a host computer” and the “fingerprint data” in the host management table 11a, the host computer can be identified. As a matter of course, when data (IP address or the like) from which a host computer can be directly identified is input from the input means 53 or the USB device 41 (keyboard, or the like), without using such a host management table 11a, a host computer can be identified.

As the connection managing means 12 for making a connection to a host computer selected by the host selector 11b via the LAN network 3, a connection management table 12a and a connection managing unit 12b are provided. The connection managing unit 12b controls a connecting operation to the host computer by referring to the connection management table 12a. In the connection management table 12a, information necessary for connection to the host computer, for example, an IP address of the host computer and a connection status between the USB device and the host computer are stored.

The connection managing unit 12b manages the whole connection processing of the remote control device 1. It manages the processing not only when the remote control device 1 actively starts connection processing but also when the remote control device 1 passively responds to a connection request from the host computer. Therefore, when the host computer includes a host side connection managing means 28, a connection request may be transmitted from the host computer to the remote control device 1. In this case, the connection managing unit 12b judges whether the USB device 41 that has received this connection request is being connected to another host computer by referring to the connection management table 12a. When it is being connected, “occupied by another host computer” is replied to the host computer that has issued the connection request.

The remote control device 1 includes a tunneling driver 13 as a data converting means for mutual protocol conversion between input/output data of the USB device 41 connected to the peripheral device interface means 14 and network communication packet data, and transmits or receives network communication packet data to or from the host computer selected by the host selector 11b by using the network communicating means 15 composed of the LAN I/F 15b and the LAN controller 15a.

The remote control device 1 includes an authenticating means 16 for judging whether a user has authorization to remotely control the host computer selected by the host selector 11b. The authenticating means 16 includes a comparing data table 16a and an authenticating unit 16b. In the comparing data table 16a, authentication information of a user who is permitted to use the remote control device 1 is registered in advance. The authenticating unit 16b performs conversion and comparison of authentication information input from an authentication device. Herein, the authentication device to be used by a user for inputting authentication information is, for example, a fingerprint sensor, an IC card reader, or a keyboard. In an example, these authentication devices are USB devices and are connected to the peripheral device interface means 14 of the remote control device 1. It is also possible that authentication information is input via the input means 53 provided integrally with the remote control device 1. Authentication information means information from which a user can be uniquely identified, and is, for example, ID information of an IC card, fingerprint data, a password, or the like.

The remote control device 1 includes an input device data switching means 17 for switching the control authority of the USB device 41 connected to the peripheral device interface means 14. When a connection between the remote control device 1 and the host computer is not established at a driver level, the input device data switching means 17 delivers data input from the USB device 41 to a USB class driver 18 so that the data is processed as input data to be input into the remote control device 1. While, when a connection between the remote control device 1 and the host computer is established at a driver level, the input device data switching means 17 delivers data input from the USB device 41 to the tunneling driver 13 so that the data is processed as data for the host computer to which connection is established. Herein, the connection at the driver level means a connection between the tunneling driver 13 of the remote control device 1 and the tunneling driver 22 of the host computer 2, and by establishing this connection, it becomes possible to transmit and receive USB data via the LAN network 3.

FIG. 4 shows a processing flow of the input device data switching means 17.

First, at Step S41, when the input device (USB device, and herein, a keyboard) is connected to the remote control device 1, the remote control device 1 recognizes this USB device to make it available. More specifically, a USB plug and play mechanism (not shown) of the remote control device 1 operates and judges that the connected USB device is a keyboard, mounts a corresponding USB class driver 18 (USB class driver for controlling the keyboard in this case), and makes the input device (keyboard) available.

At Step S42, a user selects a host computer by inputting host computer selection information (IP address, host name, or the like) from the input device (keyboard). Herein, data input from the input device (keyboard) is processed as input data to be input for the remote control device 1. Therefore, when the input data is data for selecting a host computer, the data is supplied to the host selector 11b. The host selector 11b identifies a host computer to be connected based on the input data (host computer selection information), notifies the connection managing unit 12b of this information, and makes the connection managing unit 12b perform connection processing at a driver level.

At Step S43, the connection managing unit 12b judges whether a connection to the host computer has been established.

When a connection to the host computer at the driver level is established, at Step S44, the connection managing unit 12b notifies the input device data switching means 17 of this. By receiving this notification, the input device data switching means 17 transfers the management function of the input device (keyboard) to the tunneling driver 13 so that the data input from the input device (keyboard) is processed as data for the host computer. Thereafter, the data input from the input device (keyboard) is delivered to the tunneling driver 13 and the data input from the input device (keyboard) is processed as data for the selected host computer. That is, by operating the input device (keyboard), the user can control the host computer positioned distant via the LAN network.

At Step S45, the connection managing unit 12b judges whether the connection to the host computer at the driver level has been disconnected. There are several types of disconnection processing, details of which will be described later.

When the connection to the host computer is disconnected, at Step S46, the connection managing unit 12b notifies the input device data switching means 17 of this, and the input device data switching means 17 transfers the management of the input device (keyboard) to the USB class driver 18. Thereafter, data input from the input device (keyboard) is processed as input data to be input for the remote control device 1.

Next, a functional block diagram of the host computer 2 will be described with reference to FIG. 2.

The host computer 2 may be a general personal computer, and in the following description, an example using Windows (registered trademark) XP as an operating system (OS) is shown. However, the present invention is also applicable to other operating systems.

The host computer 2 includes a host side network communicating means 21 composed of a LAN I/F 21a and a LAN controller 21b, and similarly to the remote control device 1, the host computer includes a tunneling driver 22 as a host side data converting means for converting network communication packet data to be received from or transmitted to the remote control device 1 via the LAN network 3 into input/output data of the USB device 41.

The tunneling driver 22 communicates input/output data of the USB device 41 connected to the remote control device 1 with various applications A through C (27a, 27b, and 27c) via the USB class driver 25 and a driver 26 for USB devices.

Thus, the tunneling driver 13 of the remote control device 1 and the tunneling driver 22 of the host computer 2 perform processings necessary for communication via the LAN network 3, so that the USB class driver 25 and the driver 26 of the host computer 2 and the USB port driver 14a of the remote control device 1 do not recognize the existence of the LAN network 3 in the transmitting and receiving path of input/output data of the USB device 41 at all.

The host computer 2 includes an application starting means 23 for starting applications A through C (27a, 27b, and 27c) in response to a signal from the remote control device 1. Thereby, it becomes possible to automatically start a screen saver or other applications in response to a signal from the remote control device 1. Details of the application starting means 23 will be described later.

In addition, a host side authenticating means 24 is provided, so that it becomes possible to judge and check whether a user who operates the remote control device 1 has authorization to control the host computer 2. More specifically, authentication information of a user who has authorization to access the host computer 2 is registered in advance in the host side authenticating means 24, and when a connection request is received from the remote control device 1, the authentication information registered in the host side authenticating means 24 and authentication information input by the remote control device 1 are compared, whereby the user's access authority can be authenticated. Authentication information to be registered in the host side authenticating means 24 may be registered in advance from an authentication device connected to the host computer 2. As in the case of the remote control device 1, authentication information is, for example, ID information of an IC card, fingerprint data, a password, or the like.

In addition, a host side connection managing means 28 for connection management by the host computer 2 side is provided. The host side connection managing means 28 collects information on one or a plurality of remote control devices connected to the LAN network 3 (also including information on USB devices connected to the remote control devices), and displays these as a list on the GUI of the host computer 2. A user selects a remote control device and a USB device which should be connected while looking at the list, and gives a connection command thereto. The information is also used for disconnecting the connection to the remote control device by the host computer side. More specifically, a user who operates the host computer 2 can give a disconnection command to the remote control device 1 by operating the GUI of the host side connection managing means 28.

Next, FIG. 3 shows a processing flow of the remote control device 1 in the remote control system of the present invention. With reference to this, general operation procedures of the remote control system of the present invention will be described. In this case, to the USB port 14b of the remote control device 1, an input device (for example, a numerical keypad), an authentication device (for example, a fingerprint sensor), and a USB device (for example, a scanner) to be controlled are connected, respectively.

(1) First, a host computer is selected in the remote control device 1. Herein, a host computer is selected by inputting an IP address of the host computer from the input device connected to the remote control device 1 via the USB port 14b (Step S31). As information to be input for selecting a host computer, in addition to the above-described information, a host name and a host number (in this case, a unique number is assigned to each host computer and registered in the host management table 11a in advance, and this is referred to when the host selector 11b selects a host computer) may be used.

(2) When the selected host computer is not started, the host computer is started by the host computer starting function (described in detail later).

(3) A user inputs authentication information (herein, fingerprint data) with an authentication device connected to the USB port 14b of the remote control device 1. Then, the authenticating unit 16b of the remote control device 1 compares whether the input authentication information matches with authentication information (authentication information of a user who has authorization to use) registered in the comparing data table 16a (Step S32).

(4) As a result of comparison by the authenticating unit 16b (Step S33), when a user is not authenticated, the processing is ended.

(5) As a result of comparison by the authenticating unit 16b (Step S33), when the user is authenticated as a valid user, a connection to the selected host computer is established at a driver level (Step S34). At this time, it becomes possible to transmit and receive input/output data of the USB device (scanner) connected to the remote control device 1 to and from the selected host computer (Step S35).

(6) Transmission or receiving of the input/output data of the USB device (scanner) to or from the host computer is continued until a disconnection determination (Step S36) is made in the remote control device 1.

Herein, the disconnection determination in the remote control device 1 will be described. The remote control device 1 stops data transmission to and receiving from the selected host computer and disconnects the communication when any of the following conditions a) through c) are satisfied (Step S37). The following disconnection determinations are just examples, and other disconnection determinations may be used.
a) when the host computer issues a disconnection request
b) when the remote control device issues a disconnection request
c) in the case of time-out (time-out occurs inside the remote control device in such a case where data transmission to and receiving from the USB device cannot be performed in a predetermined period of time)

Hereinafter, basic functions of the remote control system of the present invention will be described.

(Host Computer Search Function)

The host computer search function is a function for periodically searching for host computers connected to the LAN network 3 and adding these to the host management table 11a inside the remote control device 1. FIG. 5 shows a schematic view of the host computer search function. Procedures of searching for host computers are as follows.

(1) A query is broadcasted by the remote control device 1.

(2) Host computers (2a, 2b, and 2c) connected to the LAN network 3 respond.

(3) IP addresses of the host computers (2a, 2b, and 2c) are added to the host management table 11a inside the remote control device 1.

Information stored in the host management table 11a can be displayed as a list on the operation panel or the like of the remote control device 1. Thereby, a user can know information of host computers existing on the LAN network 3 at the location of the remote control device 1. When selecting a host computer, a user can select a host computer that should be connected based on information displayed on the operation panel or the like of the remote control device 1.

(Screensaver Lock Function)

The screen saver lock function is a function for starting a screen saver of the host computer 2 when a connection at a driver level is made to the host computer 2 from the remote control device 1. Thereby, security is ensured and operations from the host computer 2 are blocked. More specifically, when the connection at a driver level is established from the remote control device 1 to the host computer 2, the screen saver is started by the application starting means 23 of the host computer 2. FIG. 6 is a schematic view showing a screen saver lock function of the host computer 2. Screensaver lock procedures of the host computer 2 are as follows.

(1) A connection at a driver level is established from the remote control device 1 to the host computer 2.

(2) The application starting means 23 of the host computer 2 starts a screen saver.

(3) After using the USB device 41, when the connection between the remote control device 1 and the host computer 2 is disconnected, the host computer 2 cancels the screen saver. As another embodiment, it is also allowed that the screen saver is continued, and it is canceled when the user performs an operation for ending the screen saver on the host computer 2.

By using the screen saver lock function, the user can prevent data transferred to the host computer from being eyed by third parties. In addition, unintended operations that are performed by other users from the connection destination host computer can be prevented.

(Host Computer Starting Function)

The host computer starting function is a function for starting a host computer 2 as a connection destination selected from the remote control device 1 by means of “Wake On LAN” in the case where the host computer 2 has not been started. Herein, “Wake On LAN” is a technique which can start a computer in the status of sleep, standby, or power shutdown from a LAN by transmitting a special packet called Magic Packet (registered trademark). FIG. 7 is a schematic view of the starting function for the host computer 2. Procedures of starting the host computer 2 are as follows.

(1) A connection is attempted from the remote control device 1 to the host computer 2.

(2) When no response is made in (1), the host computer 2 is started by means of “Wake ON LAN.”

(3) A connection is made from the remote control device 1 to the host computer 2.

In view of active selection and control of a host computer by the remote control device, it is desirable that the host computer can respond to a request from the remote control device even when the host computer is in the status of sleep or the like. The host computer starting function is for realizing this requirement.

(Authentication Security Function)

An authentication security function is a function for judging whether a user has authorization to use upon inputting authentication information of the user from the authentication device (fingerprint sensor, IC card reader, keyboard, or the like, may be constructed integrally with the remote control device 1) connected to the remote control device 1. As an authentication method, there is a method in which comparison with authentication information registered in the remote control device 1 is made to judge whether the user has authorization to use the remote control device 1 and a method in which comparison with authentication information registered in the host side authenticating means 24 of the host computer 2 as a connection destination is made to judge whether the user has authorization to use this host computer 2. Either one of the methods may be used or a combination of the two methods may be used. Comparison of authentication information may be made by the remote control device 1 or the host computer 2. FIG. 8 shows a schematic view showing the authentication security function. Procedures of the processing of the authentication security function are as follows.

(1) A connection is made from the remote control device 1 to the host computer 2.

(2) Authentication information is acquired from the host computer 2.

(3) Comparison is performed and when a user is not authenticated, the connection between the remote control device 1 and the host computer 2 is disconnected.

The authentication security function realizes not only user authentication but also device authentication. Herein, device authentication means authentication for identifying a host computer 2 which is permitted to access the remote control device 1. In the case of the device authentication, for example, identification information (IP address or the like) of a host computer to which the remote control device 1 can make a connection is registered in advance in the comparing data table 16a of the remote control device 1, and only a connection to the registered host computer is permitted. Connection to a host computer that is not registered is not made. As another construction, it is also possible that identification information (IP address or the like) of the remote control device which is permitted to make a connection is registered, and only a connection request from this registered remote control device is permitted.

(Application Starting Function)

The application starting function is a function for starting an application in a host computer 2 as a connection destination selected from the remote control device 1. FIG. 9 shows a functional block diagram of the application starting means 23 in the host computer 2. FIG. 10 shows a processing flow of the application starting unit 23a.

The application starting means 23 includes an application starting unit 23a, an application registering unit 23c, and an application recording table 23b.

The application registering unit 23c registers application information in the application recording table 23b in advance for starting an application. Application information to be registered includes a device name of the USB device, a product name, and a directory path in which an application (execute file) is saved.

A file format of the application recording table 23b is described in the order of “device name,” “product name,” and “application path,” and these items may be recorded in CSV format.

Next, with reference to FIG. 10, a processing flow is described in which the host computer 2 receives a connection request from the remote control device 1 and the application starting unit 23a starts an application.

The tunneling driver 22 in the host computer 2 acquires configuration information (device descriptor, or the like) of the USB device from the remote control device 1 when a connection to the remote control device 1 at a driver level is established. The tunneling driver 22 delivers a device name and a product name included in the configuration information (device descriptor, or the like) as parameters to the application starting unit 23a. At Step S51, when the application starting unit 23a receives an application start request, an application recording table 23b is searched based on the device name and the product name and judges whether a corresponding application has been registered. At Step S52, when the corresponding application is found in the application recording table 23b, it is judged whether this application has already been started. At Step S53, when it is judged that this application has not been started, this application is started.

### EXAMPLE 1

Detailed examples including a combination of the elements of the present invention described above will be described hereinafter.

Example 1 describes a case where scanning data acquired by a scanner is safely transferred to a user's own host computer by using a fingerprint sensor. First, a general system construction of the remote control system of Example 1 will be described with reference to FIG. 11. In the remote control system of Example 1, a plurality of host computers (2a, 2b, and 2c) and the remote control device 1 are connected by a LAN network 3. To the remote control device 1, a scanner 43 and a fingerprint sensor 42 are connected by USB cables. The fingerprint sensor 42 serves as an authentication device and an input device, and the scanner 43 serves as a USB device to be controlled.

In this example, the fingerprint sensor is used not only as an authentication device but also an input device for selecting a host computer. That is, a user who uses the scanner 43 is authenticated by inputting his/her fingerprint image from the fingerprint sensor 42 and a host computer to which the remote control device should make a connection is identified based on his/her fingerprint image.

The procedures of Example 1 will be described below with reference to FIG. 2, FIG. 11, and FIG. 12. FIG. 12 is a processing flowchart of the remote control system of Example 1.

(1) Acquisition of Fingerprint Data

First, a user who uses the scanner 43 inputs his/her fingerprint image by placing his/her finger on the fingerprint sensor 42. The input fingerprint image is converted into fingerprint data in the authenticating unit 16b. The fingerprint data is held by the authenticating unit 16b and supplied to the host selecting means 11. The fingerprint data used herein is fingerprint characteristic point (minutiae) information extracted from the fingerprint image and converted into a data format suitable for the comparison purpose.

(2) Connection Request (Authenticating Unit)

The host selecting means 11 identifies a host computer to be connected when supplied with the fingerprint data. More specifically, in the host management table 11a, an IP address of the host computer to be connected and fingerprint data are associated with each other, so that the host computer to be connected is identified by referring to the table. Then, the host selector 11b supplies information on the identified host computer to the connection managing unit 12b. Herein, it is assumed that the host computer 2a is identified. If the host computer to be connected is not registered, the user is informed of an error. The error is informed by using, for example, display or sound outputting means of the remote control device.

Meanwhile, the authenticating unit 16 judges whether the user has authorization to use the remote control device 1 by referring to the comparing data table 16 in the remote control device 1. More specifically, it is judged whether fingerprint data matching with the input fingerprint data is registered in the comparing data table 16a. If it is registered, the connection managing unit 12b is notified of the connection permission. If it is not registered, a user is informed of an error.

When a host computer is identified and the user is successfully authenticated in the authenticating unit 16b, the connection managing unit 12b issues a connection request to the host side authenticating means 24 of the identified host computer (herein, host computer 2a) by using, for example, a TCP/IP protocol.

(3) Wake On LAN

Herein, if the host computer 2a does not respond to the connection request, the host computer 2a is judged as being in the status of sleep or the like, and the host computer 2a is started by the host computer starting function.

(4) Connection Request (Authenticating Unit)

When the host computer 2a is started by the host computer starting function, the connection managing unit 12b issues a connection request to the host computer 2a again.

(5) Connection Response (Authenticating Unit)

The host computer 2a makes a connection response to the remote control device 1. Thereby, a connection between the authenticating unit 16b of the remote control device 1 and the host side authenticating means 24 of the host computer 2 is established.

(6) Receiving of Fingerprint Data

When a connection is established between the host side authenticating means 24 and the authenticating unit 16b, the host side authenticating means 24 transmits finger print data registered in advance in the host computer 2a, so that the authenticating unit 16b of the remote control device 1 receives this. When transmission of the fingerprint data is finished, the connection is disconnected.

(7) Configuration Information Transmission

The authenticating unit 16b of the remote control device 1 compares fingerprint data input from the fingerprint sensor 42 with fingerprint data received from the host computer 2a. When they do not match with each other, it is judged that the user is not a valid user and an error is notified.

As a result of comparison, when the user is judged as a valid user, the authenticating unit 16b supplies this information to the connection managing unit 12b. The connection managing unit 12b transmits configuration information of a connected USB device (in this case, scanner 43) to the tunneling driver 22 of the host computer 2a by using, for example, UDP/IP protocol. The configuration information means information which defines functionality of the USB device, such as a device descriptor, and is used for USB plug and play.

(8) Connection Request (Driver)

When the tunneling driver 22 of the host computer 2a receives the configuration information, it requests a connection at a driver level to the tunneling driver 13 of the remote control device 1 by using, for example, TCP/IP protocol.

(9) Connection Response (Driver)

The tunneling driver 13 of the remote control device 1 makes a connection response to the connection request issued from the tunneling driver 22 of the host computer 2a. Thereby, a connection at a driver level is established, and transmission and receiving of USB data via a network become possible.

The connection managing unit 12b of the remote control device 1 adds the information indicating that the host computer 2a is using the USB device (scanner 43) to the connection management table 12a. More specifically, identification information (IP address, or the like) of the host computer 2a and identification information (device name, or the like) of the scanner 43 are associated with the connection management table 12a.

Meanwhile, the tunneling driver 22 of the host computer 2a supplies the received configuration information to a USB plug and play mechanism (not shown) of the OS of the host computer 2a and makes the USB plug and play operate. By this processing, the USB class driver 25 and the driver 26 of the host computer 2a become available.

(10) Screensaver Start

When the connection at a driver level is established, the tunneling driver 22 of the host computer 2a notifies the application starting means 23 of a device name and a product name included in the configuration information as parameters. The application starting unit 23a of the application starting means 23 judges whether there is any application that should be started by referring to the application recording table 23b. In this case, for example, when a screensaver is registered, the application starting unit 23a starts the screensaver.

Herein, start of the screensaver is just an example. For example, if there is an application for the scanner which needs to be started in the host computer 2a when scanning, this is recorded in the application recording table 23b. Thereby, when a connection at a driver level is established, such an application automatically starts and becomes available.

In Example 1, for example, it is assumed that the application A27a is the application necessary for scanning. The application A27a is registered in the application recording table 23b, so that it automatically becomes available when a connection at a driver level is established.

(11) USB Data Transmission and Receiving

A user starts scanning by depressing the scan button of the scanner 43.

The application A27a necessary for scanner input in the host computer 2a is started by the application starting means 23, so that the user can performs canning without returning to the location of the host computer 2a. Data scanned by the scanner 43 is encapsulated into a network protocol such as TCP/IP, and successively transmitted to the tunneling driver 22 of the host computer 2a via the LAN network 3. The tunneling driver 22 decapsulates the encapsulated data and supplies the decapsulated data to a higher layer. More specifically, such data is supplied to the application A27a which performs scanning via the USB class driver 25 and the driver 26.

(12) Disconnection Request

When a user ends the use of the scanner 43, he/she gives a disconnection command to the remote control device 1. More specifically, a disconnection command is input from the input means 53 of the remote control device 1. This disconnection command is given to the tunneling driver 13, and when this is given, the tunneling driver 13 transmits a disconnection request to the tunneling driver 22 of the host computer 2a.

(13) Disconnection Response

The tunneling driver 22 of the host computer 2a makes a disconnection response to the remote control device 1. Thereby, the connection at a driver level between the remote control device 1 and the host computer 2a is disconnected.

The connection managing unit 12b of the remote control device 1 updates the information of the connection management table 12a since the use of the USB device (scanner 43) has ended. More specifically, the information on association between the host computer 2a and the scanner 43 is deleted.

### EXAMPLE 2

Next, Example 2 describes a case where a host computer is remotely controlled by using a keyboard, a mouse, and a monitor as USB devices. More specifically, the description is given by assuming the case where an analyzer such as a spectral analyzer as a USB device is used.

FIG. 13 is a general system construction diagram of a remote control system of Example 2. Example 2 is different from Example 1 in that a monitor, a mouse, and a keyboard are connected in addition to the USB device (analyzer in this case) as a control target. The monitor, mouse, and keyboard are connected to the remote control device via USB cables.

In Example 2, by connecting a monitor, a mouse, and a keyboard to the remote control device, that is, by providing the remote control device with a similar human-machine interfaces as the connection destination host computer has, a remote control system is provided which can be used as if the remote control device were the connection destination host computer itself. In other words, the remote control device reproduces and supplies the same environment as that of the connection destination host computer to a user.

Processing procedures of Example 2 will be described hereinafter with reference to FIG. 2, FIG. 13, and FIG. 14. FIG. 14 is a processing flowchart of the remote control system of Example 2. The processing procedures of Example 2 are as follows.

(1) Input of IP Address

First, a user inputs an IP address of a host computer to which he/she wants to make a connection from the keyboard 46. Herein, the USB class driver 18 is assigned to the keyboard 46. That is, when the keyboard 46 is connected to the remote control device 1, the USB plug and play mechanism (not shown) of the remote control device 1 recognizes this and assigns the necessary USB class driver 18 in advance. Concerning the monitor 44, the mouse 45, and the analyzer 47, it is not necessary to give a command to the remote control device 1 itself by using these, so that they are constructed so as to be under control of the tunneling diver 13 from the beginning. When Data input from the keyboard 46 is the host computer selection information, it is supplied to the host selecting means 11. The host selecting means 11 identifies a host computer to be connected from the input data, and supplies information on the identified host computer to the connection managing unit 12b. Here, it is assumed that the host computer 2b is identified.

(2) Configuration Information Transmission

When information on a host computer that should be connected is supplied, the connection managing unit 12b transmits configuration information of the USB devices connected to the remote control device 1 to the tunneling driver 22 of the host computer 2b by using, for example, UDP/IP protocol. Herein, as configuration information, information on the monitor 44, the mouse 45, the keyboard 46, and the analyzer 47 is transmitted, respectively.

(3) Connection Request (Driver)

The tunneling driver 22 of the host computer 2b receives this configuration information and then issues a connection request at a driver level to the tunneling driver 13 of the remote control device 1 by using, for example, TCP/IP protocol.

(4) Connection Response (Driver)

The tunneling driver 13 of the remote control device 1 makes a connection response to the connection request issued from the tunneling driver 22 of the host computer 2b. Thereby, a connection at a tunneling driver level is established, and transmission and receiving of USB data via a network become possible.

When the connection at a driver level is established, the connection managing unit 12b of the remote control device 1 notifies the input device data switching means 17 of this. In response to this signal, the input device data switching means 17 switches the control of the keyboard 46 from the USB class driver 18 to the tunneling driver 13.

Meanwhile, the tunneling driver 22 of the host computer 2b supplies the received configuration information to the USB plug and play mechanism (not shown) of the OS of the host computer 2b to make the USB plug and play operate. The processing of the USB plug and play is the same as in Example 1. Thereby, the driver 26 (driver for controlling the monitor 44, the mouse 45, the key board 46, and the analyzer 47) of the host computer 2b is assigned, so that data transmission and receiving between the host computer 2 and the USB devices (44, 45, 46, and 47) become possible.

Thus, contents of the display of the host computer 2b are displayed on the monitor 44 connected to the remote control device 1, and it becomes possible to operate the connection destination host computer 2b by using the mouse 45 and the keyboard 46. That is, a user can remotely control the host computer 2b by operating the keyboard 46 and the mouse 45 while looking at the images on the monitor 44 connected to the remote control device 1.

(5) Application Start

A user starts an application on the host computer 2b by operating the keyboard 46 and the mouse 45 while looking at the images on the monitor 44 connected to the remote control device 1. Herein, an application necessary for using the analyzer 47 is started.

(6) USB Data Transmission and Receiving

If the analyzer meets a predetermined condition, data is transferred to the host computer 2b (however, the time for acquiring data depends on the setting of the analyzer 47).

Once the connection at a driver level is established and the driver 26 of the mouse 45 and the keyboard 46 becomes available as described in (4) above, data input from the mouse 45 and the keyboard 46 is transferred to the host computer 2b as required. Also once the connection is established and the driver 26 of the monitor 44 becomes available, contents displayed on the monitor screen of the host computer 2b side are also transferred to the remote control device 1 as required.

(7) Disconnection Request

When ending the use of the remote control system, the user gives a disconnection command to the remote control device 1. More specifically, the display of the host computer 2b is displayed on the display screen of the monitor 44, so that a user can give a disconnection command from the GUI of the host side connection managing means 28 by operating the mouse 45 and the keyboard 46 while looking at the display screen. In this case, as disconnection processing, first, a disconnection command is given to the connection managing unit 12b of the remote control device 1 by the host side connection managing means 28. Next, the connection managing unit 12b gives the disconnection command to the tunneling driver 13. The tunneling driver 13 that has received this command transmits a disconnection request to the tunneling diver 22 of the host computer 2b. As another method, as in the case of Example 1, it is also possible that the disconnection command is input from the input means 53 of the remote control device 1.

(8) Disconnection Response

The tunneling driver 22 of the host computer 2b makes a disconnection response to the remote control device 1. Thereby, the connection at a driver level between the remote control device 1 and the host computer 2b is disconnected.

In many cases, from a peripheral device such as an analyzer (spectral analyzer), data cannot be loaded into the host computer unless an application is directly operated from the host computer. As described above, by connecting a monitor, a mouse, and a keyboard to the remote control device, the remote control device itself is provided with a human-machine interface equivalent to that of the connection destination host computer. Thereby, a user can operate the remote control device as if the remote control device were the connection destination host computer. Therefore, convenience of the peripheral device is significantly improved.

After a connection is made from the remote control device to the host computer, contents displayed on the monitor of the connection destination host computer are displayed on the monitor connected to the remote control device. The mouse and the keyboard connected to the remote control device operate similarly to those directly connected to the host computer, so that a user can remotely control the connection destination host computer while looking at the monitor of the remote control device.

In addition, remote controlling of the host computer can be realized without depending on the OS (operating system).

Furthermore, by encrypting a communication processed by the tunneling driver by means of SSL (Secure Socket Layer), remote controlling while protecting the image data of the monitor and maintaining security is realized.

In the description of the embodiments of the present invention, embodiments preferred for realizing the technical idea of the present invention are described. Therefore, the present invention is not always limited to the mode described in the embodiments and can be variously modified within the scope of the technical idea of the present invention.

For example, in Example 1, access authorization of a user is authenticated based on fingerprint data input from the fingerprint sensor, however, this can be omitted. In this case, when a host computer is identified based on fingerprint data input from the fingerprint sensor, connection processing may be immediately performed at a driver level.

In Example 1, fingerprint data input from the fingerprint sensor is used as authentication information and host computer selection information, however, the host selection information and the authentication information may be separate from each other. That is, the fingerprint data may be used only for authentication. In this case, host selection information is input from the keyboard or the like, separately.

In Example 1, a disconnection request is issued from the remote control device 1, however, it may be issued from the host computer 2a. In this case, when ending the use of the USB device, a user returns to the location of the host computer and gives a disconnection command from the host side connection managing means by operating the host computer.

In Example 2, access authorization authentication for a user is not performed, however, such authentication may be performed before a connection at a driver level is established.

In Example 2, the keyboard 46 is exemplified as that being under control of the USB class driver 18 of the remote control device 1, however, other devices such as a mouse may be placed under control of the USB class driver. The control authority for the keyboard 46 is switched by the input device data switching means 17. However, this switching processing may not be performed in the case where the keyboard is used as an input device only for the remote control device 1.

In the embodiments, fingerprint data is used as authentication information, however, in addition to this, a password and ID information of an IC card can be used. Any information may be used as long as it is identification information from which a person who has authorization to access can be identified.

In addition, in the embodiments, an IP address or fingerprint data is used as host computer selection information, however, any information may be used as long as a host computer can be identified from the information. For example, the information includes information from which a host computer can be directly identified, such as a host name of the host computer, however, without limiting to these, also includes information from which a host computer can be identified by referring to external information such as a host management table. Therefore, authentication information can also be used as the host computer selection information.

When the remote control system of the present invention is used by using a physical medium such as an IC card, the remote control system may be constructed so that it automatically starts a connection to a host computer when this medium enters a range recognizable from the remote control device, and automatically disconnects the connection to the host computer when the medium comes out from the range.

For example, the case using an IC card will be described as an example. When a user inserts an IC card into an IC card reader connected to the remote control device or an IC card reader constructed integrally with the remote control device, ID information of the IC card is automatically acquired and a host computer to be connected is identified (authentication is performed if necessary), and connection processing at a driver level is performed. Then, while the IC card is inserted, this connection is continued and the USB device is made available, and when the IC card is removed from the IC card reader, this is detected and disconnection processing is automatically performed. Thereby, without the user's consciousness, connection and disconnection processings are automatically performed only by inserting and removing the IC card.

In the embodiments, a USB device is employed as an example of a peripheral device, however, it is not limited thereto. The present invention can also be realized by using a device (device complying with, for example, the IEEE 1394 standards) having another interface.

In addition, concerning the functions of the respective functional parts realized by software in the embodiments, a part or the whole thereof may be realized by hardware such as a logical circuit.

### INDUSTRIAL APPLICABILITY

The remote control system of the present invention can be used as a system for remotely controlling a host computer to increase the convenience of a peripheral device such as a USB device.

### BRIEF DESCRIPTION OF THE DRAWINGS

FIG. 1 is a general system construction diagram of a remote control system of the present invention;

FIG. 2 is a functional block diagram of the remote control system of the present invention;

FIG. 3 is a processing flowchart of the remote control system of the present invention;

FIG. 4 is a processing flowchart of an input device data switching means;

FIG. 5 is a schematic view showing a search function of a host computer;

FIG. 6 is a schematic view showing a screensaver lock function of the host computer;

FIG. 7 is a schematic view showing a starting function of the host computer;

FIG. 8 is a schematic view showing an authentication security function;

FIG. 9 is a functional block diagram of an application starting means in the host computer;

FIG. 10 is a processing flowchart of an application starting unit;

FIG. 11 is a general system construction diagram of a remote control system of Example 1;

FIG. 12 is a processing flowchart of the remote control system of Example 1;

FIG. 13 is a general system construction diagram of a remote control system of Example 2;

FIG. 14 is a processing flowchart of the remote control system of Example 2; and

FIG. 15 is a general construction diagram of a USB device server system.

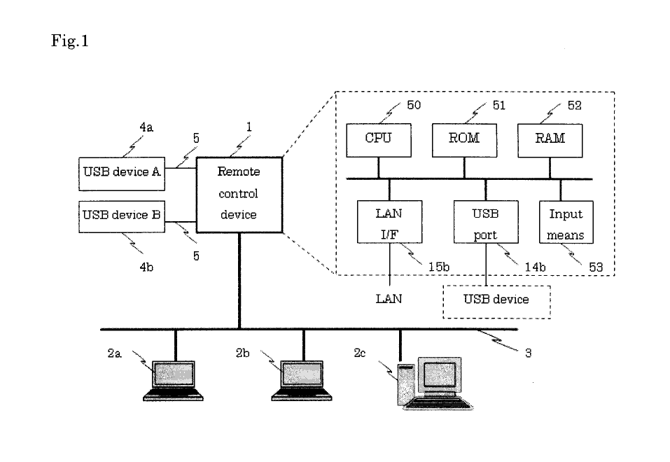

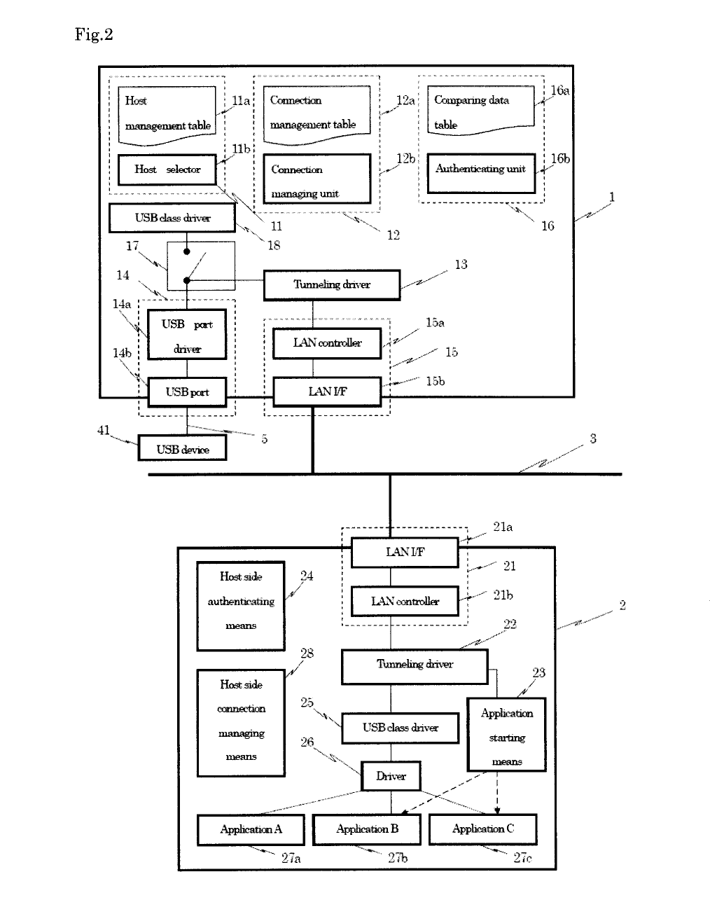

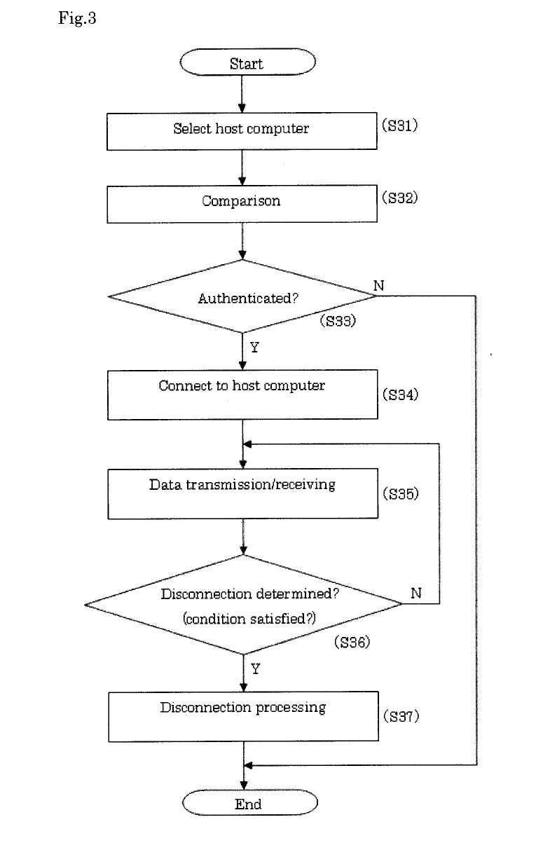

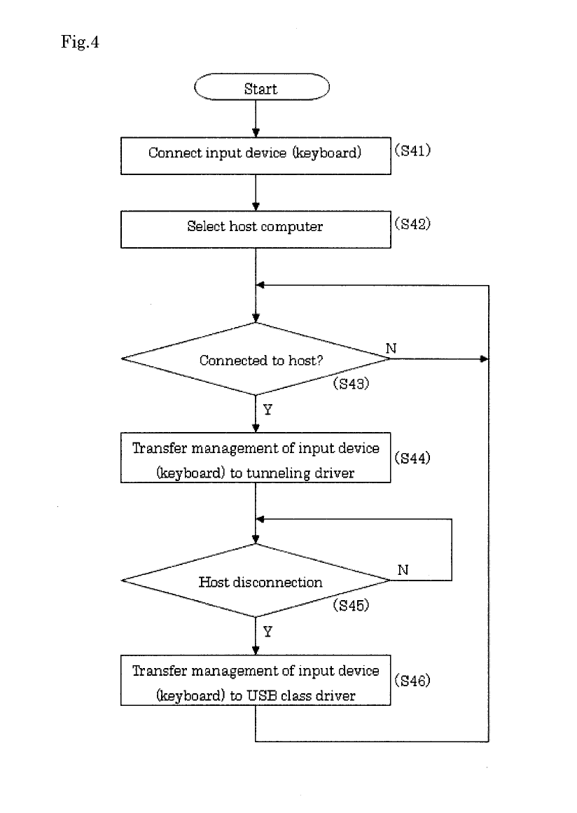

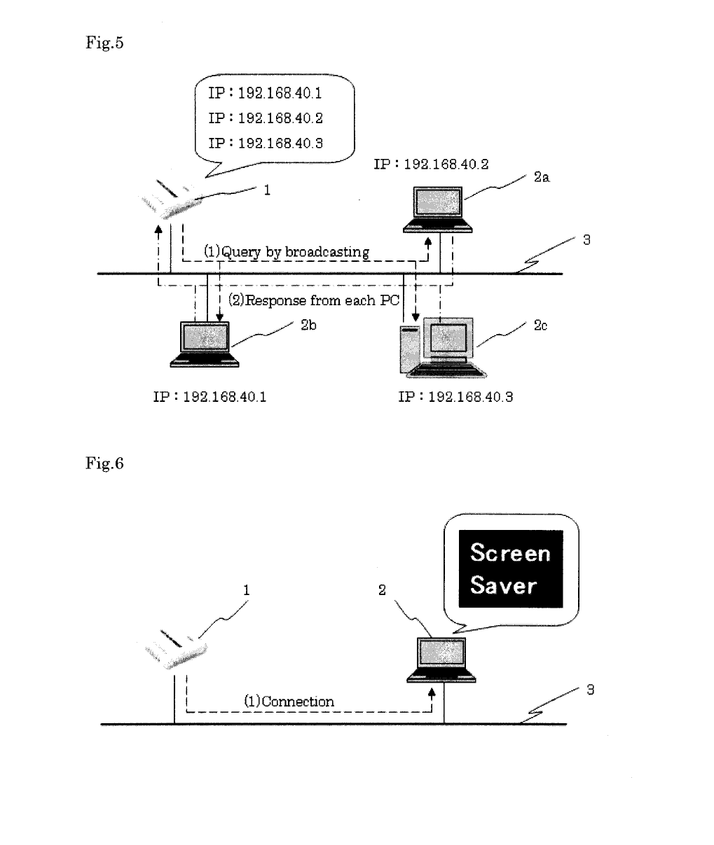

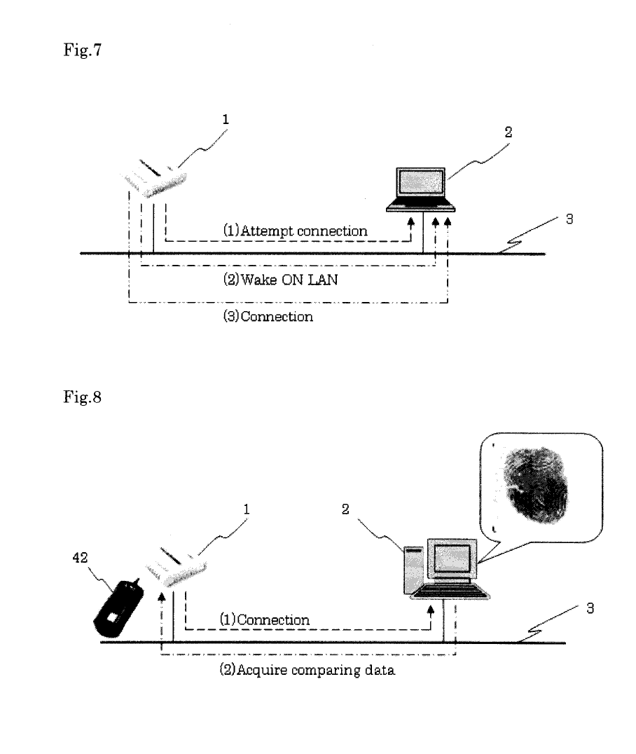

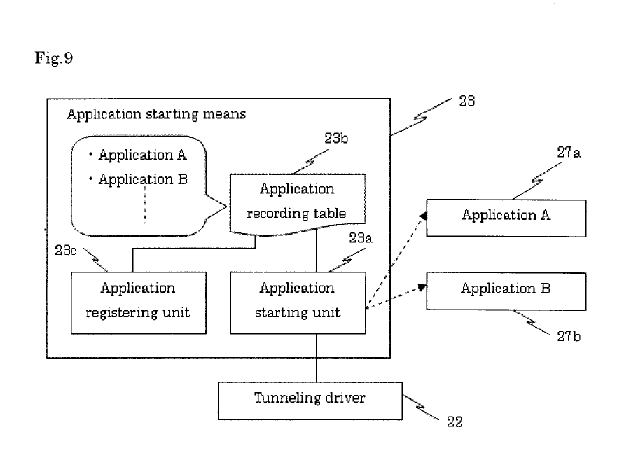

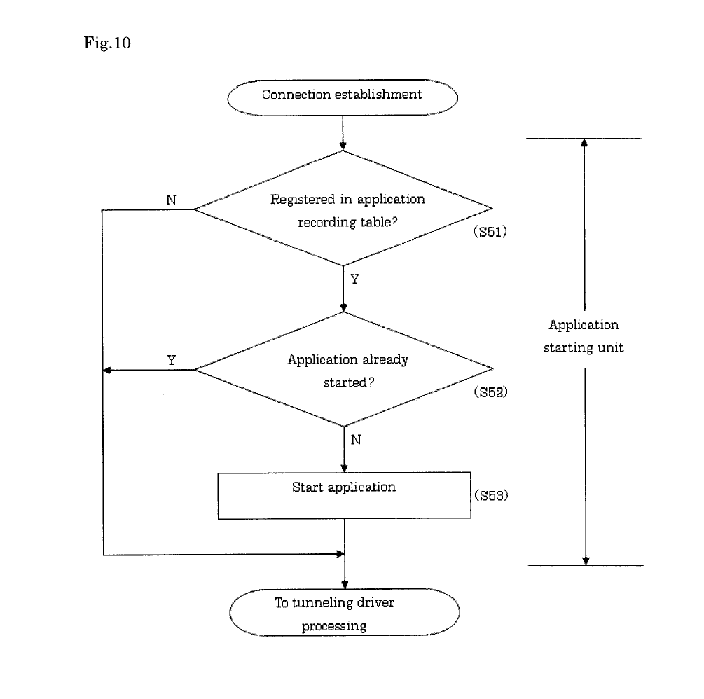

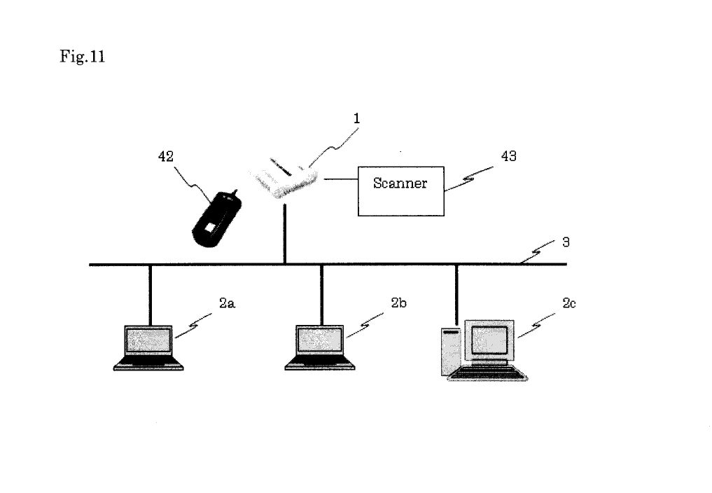

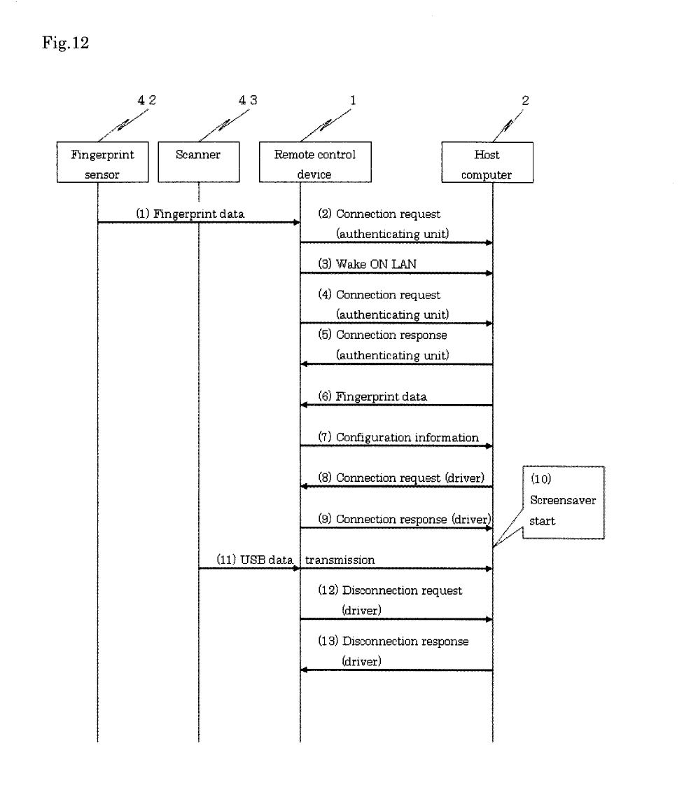

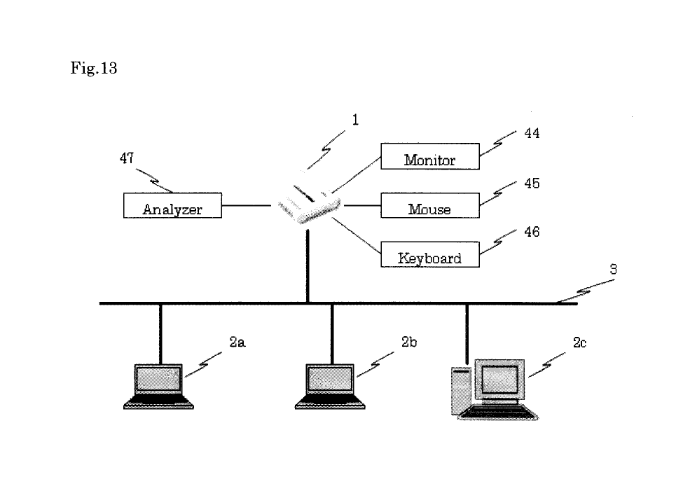

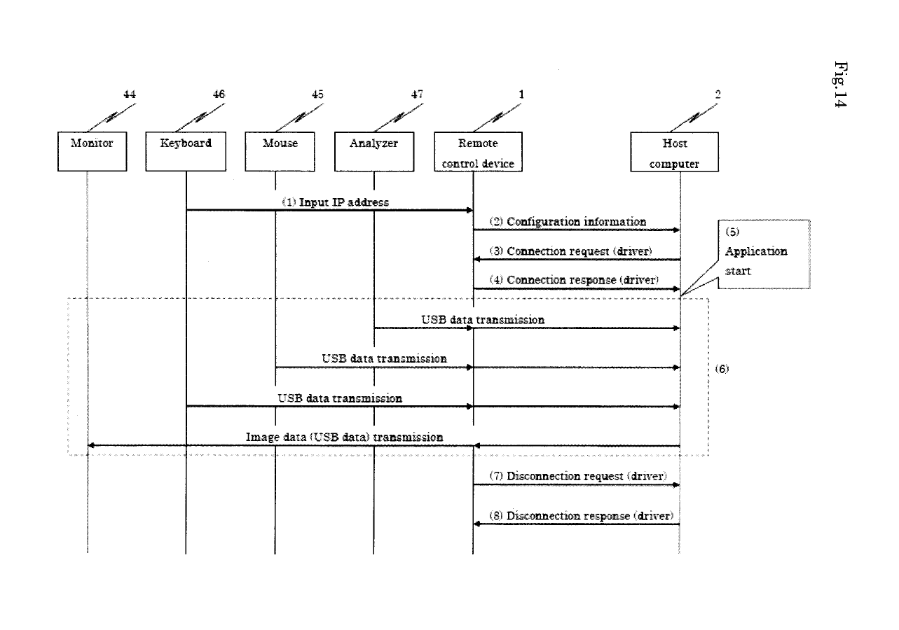

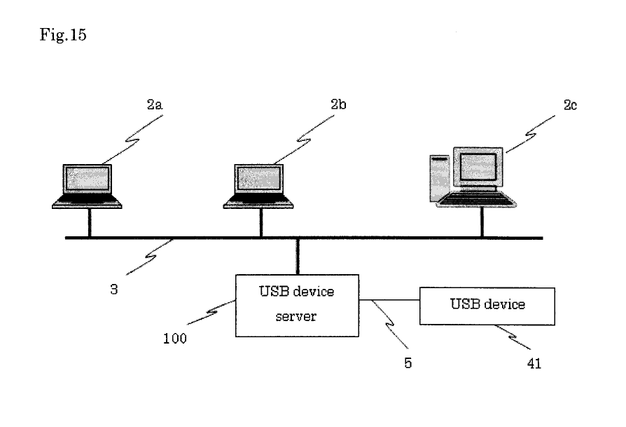

### DESCRIPTION OF SYMBOLS

1: Remote control device
2, 2a, 2b, 2c: Host computer
3: LAN network
4a, 4b: USB device
5: USB cable
11: Host selecting means
12: Connection managing means
13: Data converting means (tunneling driver)
14: Peripheral device interface means
15: Network communicating means
16: Authenticating means
17: Input device data switching means
18: USB class driver
21: Host side network communicating means
22: Host side data converting means (tunneling driver)
23: Application starting means
24: Host side authenticating means
25: USB class driver
26: Driver
27a, 27b, 27c: Application
28: Host side connection managing means
41: USB device
42: Fingerprint sensor
43: Scanner
44: Monitor
45: Mouse
46: Keyboard
47: Analyzer
100: USB device server

1. A remote control system comprising a remote control device to be connected to one or a plurality of host computers via a network, and one or a plurality of peripheral devices to be connected to the remote control device, wherein the remote control device comprises:
at least one peripheral device interface means;
a host selecting means for selecting a host computer on a network based on host computer selection information supplied from the outside;
a connection managing means for making a connection to a host computer selected by the host selecting means;
a data converting means for mutual protocol conversion between input/output data of the peripheral device connected to the peripheral device interface means and network communication packet data; and
a network communicating means for transmitting and receiving the network communication packet data to and from the host computer selected by the host selecting means, and the host computer comprises:
a host side network communicating means for transmitting and receiving the network communication packet data; and
a host side data converting means for mutual protocol conversion between network communication packet data to be received from or transmitted to the remote control device via the host side network communicating means and input/output data of the peripheral device.

2. The remote control system according to claim 1, further comprising: a data input means and an image display means to be connected to the peripheral device interface means of the remote control device, wherein data input from the data input means is transmitted as data to be processed by a host computer selected by the host selecting means to this host computer via the data converting means and the network communicating means, and image display data of this host computer is received via the host side data converting means and the network communicating means, and displayed by the image display means via the data converting means.

3. The remote control system according to claim 1, wherein
the remote control device further comprises: an input device data switching means, and
when a connection between the remote control device and the host computer is not established, the input device data switching means allows data input from the peripheral device to be processed as input data for the remote control device, and when a connection between the remote control device and the host computer is established, the input device data switching means allows data input from the peripheral device to be processed as data for the host computer.

4. The remote control system according to claim 1, wherein
the remote control device further comprises an authenticating means, wherein the authenticating means performs at least one of the following processings (1) through (3) of:
(1) comparing whether authentication information supplied from the outside and authentication information registered in the authenticating means match with each other;
(2) comparing whether authentication information supplied from the outside and authentication information supplied from the host computer match with each other; and
(3) comparing whether the host computer selection information matches with host computer information registered in the authenticating means.

5. The remote control system according to claim 4, wherein the authentication information is used as host computer selection information.

6. The remote control system according to claim 1, wherein
the host computer further comprises a host side authenticating means, and
the host side authenticating means performs at least one of the following processings (1) through (3) of:
(1) transmitting authentication information registered in advance to the remote control device in response to a request from the remote control device;
(2) comparing whether authentication information received from the remote control device and authentication information registered in advance in the host side authenticating means match with each other; and
(3) comparing whether the remote control device which has transmitted a connection request is identified with a remote control device registered in the host side authenticating means when receiving the connection request from the remote control device.

7. The remote control system according to claim 1, further comprising: an application starting means for starting a predetermined application program in response to a signal from the remote control device when the application program is not operating in a host computer.

8. A remote control device comprising, in a system comprising the remote control device to be connected to one or a plurality of host computers via a network and one or a plurality of peripheral devices to be connected to the remote control device,
at least one peripheral device interface means;
a host selecting means for selecting a host computer on a network based on host computer selection information supplied from the outside;
a connection managing means for making a connection to a host computer selected by the host selecting means;
a data converting means for mutual protocol conversion between input/output data of the peripheral device connected to the peripheral device interface means and network communication packet data; and
a network communicating means for transmitting and receiving the network communication packet data to and from a host computer selected by the host selecting means.

9. The remote control device according to claim 8, wherein
a data input means and an image display means are connected to the peripheral device interface means, and
data input from the data input means is transmitted as data to be processed by a host computer selected by the host selecting means to the host computer via the data converting means and the network communicating means, image display data of this host computer is received via the network communicating means, and displayed by the image display means via the data converting means.

10. The remote control device according to claim 8, further comprising:
an input device data switching means, wherein
the input device data switching means allows data input from the peripheral device to be processed as input data for the remote control device when a connection between the remote control device and the host computer is not established, and allows data input from the peripheral device to be processed as data for the host computer when a connection between the remote control device and the host computer is established.

11. The remote control device according to claim 8, further comprising:
an authenticating means, wherein
the authenticating means performs at least one of the following processings (1) through (3) of:
(1) comparing whether authentication information supplied from the outside and authentication information registered in the authenticating means match with each other;
(2) comparing whether authentication information supplied from the outside and authentication information supplied from the host computer match with each other; and
(3) comparing whether the host computer selection information matches with host computer information registered in the authenticating means.

12. The remote control device according to claim 11, wherein the authentication information is used as host computer selection information.

13. The remote control device according to claim 8, wherein the connection managing means judges that the host computer is in a non-start status when it cannot receive a connection response from the host computer in a predetermined time after issuing a connection request to the host computer, and transmits a signal for canceling this non-start status.

14. The control system according to claim 1, wherein the peripheral device interface means is a USB (Universal Serial Bus).

15. The remote control device according to claim 8, wherein the peripheral device interface means is a USB (Universal Serial Bus).
